(19) United States
(12) Patent Application Publication
(10) Pub. No.: US 2025/0266502 A1
(43) Pub. Date: Aug. 21, 2025

(54) LITHIUM-ION BATTERY ELECTROLYTIC SOLUTION, LITHIUM-ION BATTERY, AND METHOD FOR IMPROVING BATTERY PERFORMANCE

(71) Applicant: GUANGZHOU TINCI MATERIALS TECHNOLOGY CO., LTD., Guangzhou (CN)

(72) Inventors: Chaojun FAN, Guangzhou (CN); Gejin Cao, Guangzhou (CN); Weizhen Fan, Guangzhou (CN); Litao Shi, Guangzhou (CN)

(73) Assignee: GUANGZHOU TINCI MATERIALS TECHNOLOGY CO., LTD, Guangzhou (CN)

(21) Appl. No.: 19/201,457

(22) Filed: May 7, 2025

Related U.S. Application Data
(63) Continuation of application No. PCT/CN2023/117347, filed on Sep. 6, 2023.

(30) Foreign Application Priority Data
Dec. 6, 2022 (CN) 202211559918.0

(51) Int. Cl. H01M 10/0567; H01M 4/02; H01M 4/525; H01M 4/58; H01M 10/0525; H01M 10/0568; H01M 10/0569

(52) U.S. Cl. CPC H01M 10/0567; H01M 4/525; H01M 4/5825; H01M 10/0525; H01M 10/0568; H01M 10/0569; H01M 2004/027; H01M 2004/028; H01M 2300/0037

(57) ABSTRACT

Disclosed is an electrolytic solution for a lithium-ion battery. The electrolytic solution includes a first additive and a second additive; where the first additive is lithium tetrafluorooxalate phosphate, and the second additive is represented by the following formula. Moreover, further provided are a lithium-ion battery based on the electrolytic solution and related use of the electrolytic solution.

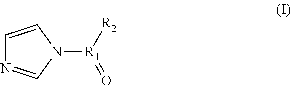

### CROSS-REFERENCE TO RELATED APPLICATIONS

This application is a continuation of International Patent Application No. PCT/CN2023/117347, filed on Sep. 6, 2023, which claims the priority to Chinese Patent Application NO. 202211559918.0 filed before China National Intellectual Property Administration on Dec. 6, 2022, titled “LITHIUM-ION BATTERY ELECTROLYTIC SOLUTION, LITHIUM-ION BATTERY, AND METHOD FOR IMPROVING BATTERY PERFORMANCE”. Both of the applications are incorporated herein by reference in their entirety.

### TECHNICAL FIELD

The present application relates to the field of lithium-ion battery, in particular to an electrolytic solution for a lithium-ion battery, a lithium-ion battery and a method for improving battery performance.

### BACKGROUND

A lithium-ion battery has the characteristics of a long cycling life, high specific energy, a short charging time, a compact size, light weight and the like, which is widely favored by people and has been widely used in electronic products. The performance of lithium-ion battery is predominantly determined by a composition of organic electrolytic solution and a composition of SEI film formed by the reactions between organic electrolytic solution and electrode.

Lithium tetrafluoro(oxalato)phosphate (LiTFOP), as an electrolytic solution additive for lithium-ion battery, shows relatively good improvements in low-temperature DCR, low-temperature discharge performance, and high-voltage room-temperature cycling when used individually. However, it exhibits certain adverse effects on high-temperature storage and high-temperature cycling.

The non-aqueous electrolytic solution disclosed in CN103208652A includes a first additive of lithium difluorobis(oxalato)phosphate and a second additive of lithium tetrafluoro(oxalato)phosphate, where an added amount of the first additive is at least 0.3 wt % and less than 1.0 wt % of a total weight of the non-aqueous electrolytic solution, and an added amount of the second additive is at least 0.05 times and less than 0.3 times of that of the first additive; the specification recites that the combination of the two additives synergistically improves the problem of easy decomposition of the electrolytic solution.

However, in practical research, it is found that LiTFOP itself is unstable and easy to decompose, leading to a significant increase in an acid value of the electrolytic solution, which is not conducive to quality management.

In this field, the combined use of lithium tetrafluoro(oxalato)phosphate (LiTFOP) and other additives has also been implemented in some cases. For example, CN113130997A provides a lithium-ion battery, a preparation method thereof and an electric vehicle including the lithium-ion battery. The electrolytic solution of the lithium-ion battery includes an additive A and an additive B, where the additive A is one or more of cyclic sulfate compounds is represented by Formula 1 and Formula 2, and the additive B is lithium difluorobis(oxalato)phosphate and/or lithium tetrafluoro(oxalato)phosphate. This application can reduce the gas production of the lithium-ion battery, prolong the cycling life and storage life of the lithium-ion battery, and significantly inhibit the increase of the direct current internal resistance of the lithium-ion battery during the cycle and storage.

However, in the long-term exploration, we found that it is difficult to screen out an additive that can synergistically inhibit the increase of acidity of lithium tetrafluoro(oxalato)phosphate and improve the battery performance.

The technical problem to be solved in the present application is how to improve the high-temperature performance defect and solve the problem of increased acidity of electrolytic solution caused by stability defect of lithium tetrafluoro(oxalato)phosphate by the combined use of additives.

### SUMMARY

The object of the present application is to provide an electrolytic solution for a lithium-ion battery, which is stable during storage and can synergistically improve the high- and low-temperature performance and long cycling performance of the lithium-ion battery after being used to them.

Meanwhile, the present application further provides a lithium-ion battery based on the electrolytic solution and a related use of the electrolytic solution.

In order to achieve the above object, the present application provides the following technical solutions: an electrolytic solution for a lithium-ion battery, the electrolytic solution contains a first additive and a second additive;
the first additive is lithium tetrafluoro(oxalato)phosphate, and the second additive is represented by the following Formula 1:

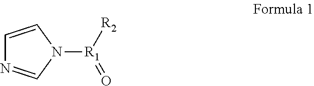

R₁ is C or S═O;
when R₁ is C, the second additive is represented by the following Formula 2:

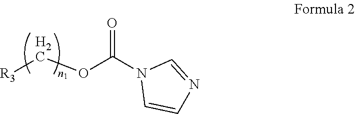

when n₁=0, R₃ is

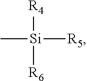

R₄, R₅ and R₆ are each independently selected from the group consisting of F, saturated hydrocarbyl with 1-3 C atoms, unsaturated alkenyl or alkynyl with 2-5 C atoms, and phenyl or substituted phenyl with 6-12 C atoms;
when n₁=1-5, R₃ is —C═C, —C≡C, —CN, or —N═C═O;
when R₁ is S═O, the second additive is represented by the following Formula 3:

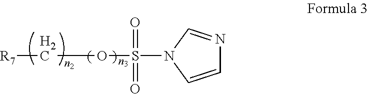

n₃=0 or 1;
when n₃=0, n₂=0, and R₇ is F, phenyl or substituted phenyl with 6-12 C atoms, imidazolyl or

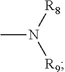

R₈ and R₉ are each independently selected from the group consisting of saturated hydrocarbyl with 1-3 C atoms, and unsaturated alkenyl or alkynyl with 3-5 C atoms;
when n₃=1, n₂=0, and R₇ is phenyl or substituted phenyl with 6-12 C atoms; or
when n₃=1, n₂=1-3, and R₇ is —C═C, —C≡C, —CN, —N═C═O, phenyl or substituted phenyl with 6-12 C atoms, or imidazolyl.

In the above electrolytic solution for the lithium-ion battery, an amount of the first additive is 0.1-1 wt % of a total amount of the electrolytic solution; an amount of the second additive is 0.05-1 wt % of the total amount of the electrolytic solution;
in the present application, the amount of the first additive can be chosen as 0.1 wt %, 0.2 wt %, 0.3 wt %, 0.4 wt %, 0.5 wt %, 0.6 wt %, 0.7 wt %, 0.8 wt %, 0.9 wt % or 1.0 wt %;
in the present application, the amount of the second additive can be chosen as 0.05 wt %, 0.1 wt %, 0.2 wt %, 0.3 wt %, 0.4 wt %, 0.5 wt %, 0.6 wt %, 0.7 wt %, 0.8 wt %, 0.9 wt % or 1.0 wt %.

In the above electrolytic solution for the lithium-ion battery, the phenyl or substituted phenyl with 6-12 C atoms is selected from the group consisting of phenyl, biphenyl, phenyl having at least one alkyl substituent, naphthyl, naphthyl having one or two methyl substituents, naphthyl having one ethyl substituent, indenyl, and indenyl having at least one alkyl substituent;
the phenyl having at least one alkyl substituent is represented by the following Formula 4;

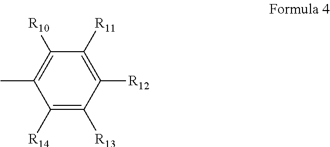

R₁₀, R₁₁, R₁₂, R₁₃ and R₁₄ are each independently selected from the group consisting of H, methyl, ethyl, propyl, n-butyl and isobutyl; a sum of carbon atoms of R₁₀, R₁₁, R₁₂, R₁₃ and R₁₄ is less than or equal to 6,
preferably, any one of R₁₀, R₁₁, R₁₂, R₁₃ and R₁₄ is methyl or ethyl, and the rest are H;
preferably, any two of R₁₀, R₁₁, R₁₂, R₁₃ and R₁₄ are methyl and/or ethyl, and the rest are H; and
preferably, the substituent on naphthyl and indenyl is located on the benzene ring; and more preferably, there is only one substituent on naphthyl and indenyl is located on the benzene ring, the substituent is methyl or ethyl.

The saturated hydrocarbyl with 1-3 C atoms is methyl, ethyl or propyl;
the unsaturated alkenyl or alkynyl with 2-5 C atoms is vinyl, allyl, propenyl, 3-butenyl, isobutenyl, 4-pentenyl, ethynyl, propargyl, 3-butynyl, 1-methyl-2-propynyl, 1-pentenyl, 2-pentenyl, 2-methyl-1-butenyl, 3-methyl-1-butenyl, or 2-methyl-2-butenyl; and
the unsaturated alkenyl or alkynyl with 3-5 C atoms is allyl, propenyl, 3-butenyl, isobutenyl, 4-pentenyl, ethynyl, propargyl, 3-butynyl, 1-methyl-2-propynyl, 1-pentenyl, 2-pentenyl, 2-methyl-1-butenyl, 3-methyl-1-butenyl, or 2-methyl-2-butenyl.

Preferably, the second additive is any one or a combination of two or more of the following compounds:

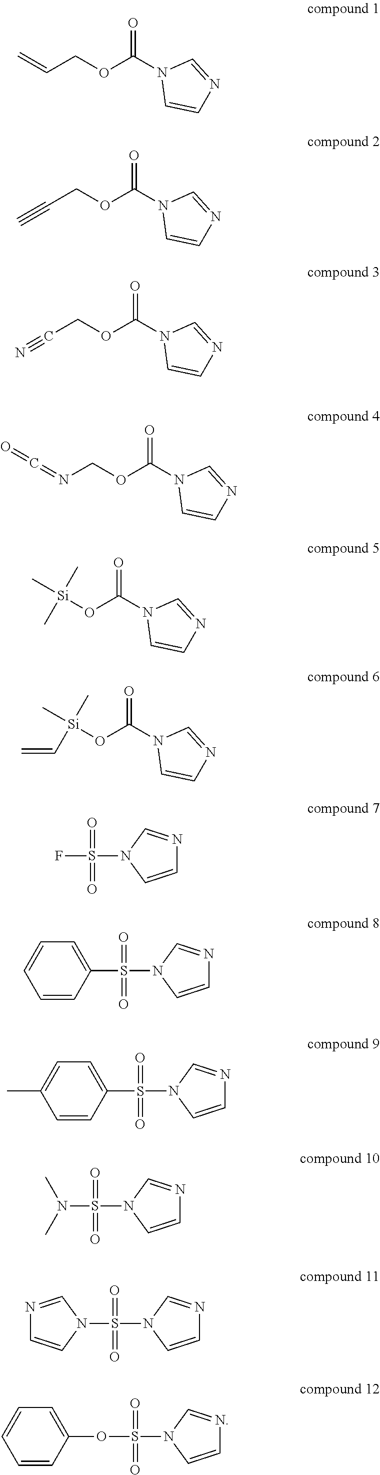

Preferably, the electrolytic solution further contains a third additive; an amount of the third additive is 0-10 wt %, preferably 0.1-5 wt %, preferably 0.1-1 wt %, more preferably 0.2-0.8 wt %, and more preferably 0.3-0.7 wt %, of the total amount of the electrolytic solution;
the third additive can be selected from the group consisting of nitrile additives, aromatic additives, isocyanate additives, other triple bond-containing additives, S═O group-containing additives, cyclic acetal additives, other P-containing additives, cyclic anhydride additives, cyclic phosphazene additives, fluorine-containing additives, and a combination thereof;
more specifically, for example:
nitriles selected from the group consisting of acetonitrile, propionitrile, succinonitrile, glutaronitrile, adiponitrile, pimelonitrile, suberonitrile, sebaconitrile, and a combination thereof; aromatic compounds, such as aromatic compounds with branched alkyl, such as cyclohexylbenzene, fIuorocyclohexylbenzene compounds (1-fluoro-2-cyclohexylbenzene, 1-fluoro-3-cyclohexylbenzene, 1-fluoro-4-cyclohexylbenzene), tert-butylbenzene, tert-pentylbenzene, 1-fluoro-4-tert-butylbenzene, and the like, biphenyl, terphenyl (ortho-, meta-, para-isomer), diphenyl ether, fluorobenzene, difluorobenzene (ortho-, meta-, para-isomer), anisole, 2,4-difluoroanisole, partially hydrogenated terphenyl (1,2-dicyclohexylbenzene, 2-phenyldicyclohexyl, 1,2-diphenylcyclohexane, o-cyclohexylbiphenyl), and the like; isocyanate compounds selected from the group consisting of methyl isocyanate, ethyl isocyanate, butyl isocyanate, phenyl isocyanate, tetramethylene diisocyanate, hexamethylene diisocyanate, octamethylene diisocyanate, 1,4-phenylene diisocyanate, 2-isocyanatoethyl acrylate, 2-isocyanatoethyl methacrylate, and a combination thereof; triple bond-containing compounds selected from the group consisting of methyl 2-propynyl carbonate, 2-propynyl acetate, 2-propynyl formate, 2-propynyl methacrylate, 2-propynyl methanesulfonate, 2-propynyl vinylsulfonate, 2-propynyl 2-(methanesulfonyloxy)propionate, di(2-propynyl) oxalate, 2-propynyl methyl oxalate, 2-propynyl ethyl oxalate, bis(2-propynyl) glutarate, 2-butyne-1,4-diyl dimethanesulfonate, 2-butyne-1,4-diyl diformate, 2,4-hexadiyne-1,6-diyl dimethanesulfonate, and a combination thereof; S═O group-containing compounds selected from the group consisting of sultones, such as 1,3-propanesultone, 1,3-butane sultone, 2,4-butane sultone, 1,4-butane sultone, prop-1-ene-1,3-sultone, 2,2-dioxido-1,2-oxathiolane-4-yl acetate, 5,5-dimethyl-1,2-oxathiolane-4-one 2,2-dioxide, cyclic sulfites, such as ethylene sulfite, hexahydrobenzo[1,3,2]dioxathiolane-2-oxide (also known as 1,2-cyclohexanediol cyclic sulfite), 5-vinyl-hexahydro-1,3,2-benzodioxathiol-2-oxide, sulfonates, such as butane-2,3-diyl dimethanesulfonate, butane-1,4-diyl dimethanesulfonate, methylene methanedisulfonate, and a combination thereof; vinyl sulfone compounds, such as divinyl sulfone, 1,2-bis(vinylsulfonyl)ethane, bis(2-vinylsulfonylethyl)ether, and the like; cyclic acetal compounds selected from the group consisting of 1,3-dioxolane, 1,3-dioxane, 1,3,5-trioxane, and a combination thereof; phosphorus-containing compounds selected from the group consisting of trimethyl phosphate, tributyl phosphate, trioctyl phosphate, tris(2,2,2-trifluoroethyl) phosphate, bis(2,2,2-trifluoroethyl)methyl phosphate, bis(2,2,2-trifluoroethyl)ethyl phosphate, bis(2,2,2-trifluoroethyl) 2,2-difluoroethyl phosphate, bis(2,2,2-trifluoroethyl) 2,2,3,3-tetrafluoropropyl phosphate, bis(2,2-difluoroethyl) 2,2,2-trifluoroethyl phosphate, bis(2,2,3,3-tetrafluoropropyl) 2,2,2-trifluoroethyl phosphate, (2,2,2-trifluoroethyl)(2,2,3,3-tetrafluoropropyl) methyl phosphate, tris(1,1,1,3,3,3-hexafluoropropane-2-yl) phosphate, methyl methylene diphosphonate, ethyl methylene diphosphonate, methyl ethylene diphosphonate, ethyl ethylene diphosphonate, methyl butylene diphosphonate, ethyl butylene diphosphonate, methyl 2-(dimethylphosphono)acetate, ethyl 2-(dimethylphosphono)acetate, methyl 2-(diethylphosphono)acetate, ethyl 2-(diethylphosphono)acetate, 2-propynyl 2-(dimethylphosphono)acetate, 2-propynyl 2-(diethylphosphono)acetate, methyl 2-(dimethoxyphosphono)acetate, ethyl 2-(dimethoxyphosphono)acetate, methyl 2-(diethoxyphosphono)acetate, ethyl 2-(diethoxyphosphono)acetate, 2-propynyl 2-(dimethoxyphosphono)acetate, 2-propynyl 2-(diethoxyphosphono)acetate, methyl pyrophosphate, ethyl pyrophosphate, and a combination thereof; chain carboxylic anhydrides, such as acetic anhydride, propionic anhydride, or cyclic anhydrides, such as succinic anhydride, maleic anhydride, 2-allylsuccinic anhydride, glutaric anhydride, itaconic anhydride, 3-sulfo-propionic anhydride and the like; cyclic phosphazene compounds, such as methoxypentafluorocyclotriphosphazene, ethoxypentafluorocyclotriphosphazene, phenoxypentafluorocyclotriphosphazene, or ethoxyheptafluorocyclotetraphosphazene, and the like; fluorinated compounds, such as fluorinated ethyl methyl carbonate, fluorinated dimethyl carbonate, fluorinated diethyl carbonate, fluorinated ethyl propionate, fluorinated propyl propionate, fluorinated methyl propionate, fluorinated ethyl acetate, fluorinated methyl acetate, or fluorinated propyl acetate, and the like; and
more preferably, the third additive is selected from the group consisting of:
vinylene carbonate, vinyl ethylene carbonate, ethylene sulfate, propylene carbonate, 1,3-propanesultone, prop-1-ene-1,3-sultone, 1,4-butane sultone, 2,4-butane sultone, succinic anhydride, maleic anhydride, 2-methylmaleic anhydride, 2-propynyl methyl carbonate, tetravinylsilane, triallyl isocyanurate, hexamethylene diisocyanate, o-phenanthroline, p-phenyl diisocyanate, 2,4-toluene diisocyanate, N-phenyl-bis(trifluoromethanesulfonly)imide, phenyl methanesulfonate, pentaerythritol bicyclic sulfate, hydroquinone bisfluorosulfonate, triallyl phosphate, tripropynyl phosphate, 2,4-butane sulfone, isocyanatoethyl methacrylate, methylene methanedisulfonate, tris(trimethylsilyl)borate, tris(trimethylsilyl)phosphate, tris(vinyldimethylsilyl)phosphate, 4,4′-bi-1,3-dioxolane-2,2′-dione, propyl diprop-2-ynyl phosphate, ethyl diprop-2-ynyl phosphate, (2-allylphenoxy)trimethylsilane, tetramethyl methylenediphosphonate, isocyanatoethyl methacrylate, 2-fluoropyridine and a combination thereof.

Preferably, the electrolytic solution contains a lithium salt and a non-aqueous organic solvent as the balance; an amount of the lithium salt is 8-25 wt % of the total amount of the electrolytic solution; and generally, the suitable concentration of the lithium salt in the art is 0.5-3 M; preferably, the concentration of the lithium salt is 0.8-2.5 M; preferably, the concentration of the lithium salt is 1-2 M; and more preferably, the concentration of the lithium salt is 1-1.5 M;
in practical application, the amount of lithium salt can be more, for example, up to 35%, which is also potentially feasible;
as for the lithium salt in the non-aqueous electrolytic solution of the present application, there is no particular limitation, and it can be used at will as long as it is a known lithium salt used in the present application, and the following lithium salts can be specifically listed;
for example, inorganic lithium salts, such as LiPF₆, LiBF₄, LiClO₄, LiAlF₄, LiSbF₆, LiTaF₆, LiWF₇, and the like; lithium tungstates, such as LiWOF₅, and the like;
lithium carboxylates, such as HCO₂Li, CH₃CO₂Li, CH₂FCO₂Li, CHF₂CO₂Li, CF₃CO₂Li, CF₃CH₂CO₂Li, CF₃CF₂CO₂Li, CF₃CF₂CF₂CO₂Li, CF₃CF₂CF₂CF₂CO₂Li, and the like;
lithium sulfonates, such as FSO₃Li, CH₃SO₃Li, CH₂FSO₃Li, C H F₂SO₃Li, C F₃SO₃Li, CF₃CF₂SO₃Li, CF₃CF₂CF₂SO₃Li, CF₃CF₂CF₂CF₂SO₃Li, and the like;
imide lithium salts, such as LiN(FCO)₂, LiN(FCO)(FSO₂), LiN(FSO₂)₂, LiN(FSO₂)(CF₃SO₂), LiN(CF₃SO₂)₂, LiN(C₂F₅SO₂)₂, cyclic 1,2-perfluoroethane disulfonylimide lithium, cyclic 1,3-perfluoropropane disulfonylimide lithium, LiN(CF₃SO₂)(C₄F₉SO₂), and the like;
methylated lithium salts, such as LiC(FSO₂)₃, LiC(CF₃SO₂)₃, LiC(C₂F₅SO₂)₃, and the like; lithium(oxalato)borates, such as lithium difluoro(oxalato)borate and lithium bis(oxalato)borate, and the like;
lithium(oxalato)phosphates, such as lithium difluorobis(oxalato)phosphate and lithium tri(oxalato)phosphate, and the like; and
fluorine-containing organolithium salts, such as LiPF₄(CF₃)₂, LiPF₄(C₂F₅)₂, LiPF₄(CF₃SO₂)₂, LiPF₄(C₂F₅SO₂)₂, LiBF₃CF₃, LiBF₃C₂F₅, LiBF₃C₃F₇, LiBF₂(CF₃)₂, LiBF₂(C₂F₅)₂, LiBF₂(CF₃SO₂)₂, LiBF₂(C₂F₅SO₂)₂, and the like.

These lithium salts can be used alone or in combination of two or more.

Further preferably, in the present embodiment, the lithium salt is selected from the group consisting of LiPF₆, LiAsF₆, LiClO₄, LiBF₄, LiB(C₂O₄)₂, LiBF₂C₂O₄, LiTDI, LiN(SO₂F)₂, LiN(SO₂CF₃)₂, LiPO₂F₂, LiPF₂(C₂O₄)₂, lithium perfluorobutane sulfonate, and combination thereof;
in the present application, the non-aqueous organic solvent is a cyclic compound and/or a linear compound;
the cyclic compound is selected from the group consisting of ethylene carbonate, propylene carbonate, γ-butyrolactone, sulfolane, fluoroethylene carbonate, difluoroethylene carbonate, 4-(2,2,2-trifluoroethoxy)-1,3-dioxolan-2-one, fluoropropylene carbonate, 3,3,3-trifluoropropylene carbonate, 4-(2,2,2-trifluoroethyl)-1,3-dioxolan-2-one, and a combination thereof;
the linear compound is selected from the group consisting of dimethyl carbonate, ethyl methyl carbonate, diethyl carbonate, methyl propyl carbonate, ethyl acetate, propyl propionate, ethyl propionate, propyl acetate, methyl propionate, 1,1,2,2-tetrafluoroethyl-2,2,3,3-tetrafluoropropyl ether, and 2,2-difluoroethyl acetate, trifluoroethyl acetate, ethyl difluoroacetate, ethyl trifluoroacetate, methyl acetate, propylene glycol methyl ether acetate, 2-methoxy-1-propyl acetate, n-propyl acetate, tris(2-ethylhexyl) trimellitate, and a combination thereof.

The above description of the organic solvent does not mean that the above solvent system cannot contain other types of solvents. As common solvents used for the lithium salt such as cyclic carboxylates, chain carboxylates, ether compounds and sulfone compounds can be added;
more preferably, in the present application, an added amount of the above cyclic carboxylates, chain carboxylates, ether compounds and sulfone compounds is generally not limited, and it is preferably not more than 30 wt % of the solvent;
a specific substance of cyclic carboxylates can be chosen as γ-butyrolactone, γ-valerolactone, γ-caprolactone, ε-caprolactone, and the like. These substances can avoid the decrease of conductivity, inhibit the increase of negative electrode resistance, and easily make the high current discharge characteristics of non-aqueous electrolyte secondary battery reach a good range;
the chain carboxylate is preferably a chain carboxylate with 3-7 carbon atoms. Specific examples include: methyl acetate, ethyl acetate, n-propyl acetate, isopropyl acetate, n-butyl acetate, isobutyl acetate, tert-butyl acetate, methyl propionate, ethyl propionate, n-propyl propionate, isopropyl propionate, n-butyl propionate, isobutyl propionate, tert-butyl propionate, methyl butyrate, ethyl butyrate, n-propyl butyrate, isopropyl butyrate, methyl isobutyrate, ethyl isobutyrate, n-propyl isobutyrate, isopropyl isobutyrate, and the like; the chain carboxylate can inhibit the increase of negative electrode resistance, enabling the non-aqueous electrolyte battery to achieve a desirable range of high-current discharge characteristic and cycling performance;
the ether compound is preferably a chain ether with 3-10 carbon atoms or a cyclic ether with 3-6 carbon atoms, where part of hydrogen is optionally substituted by fluorine; examples of the chain ether with 3-10 carbon atoms include: diethyl ether, bis(2-fluoroethyl)ether, bis(2,2-difluoroethyl)ether, bis(2,2,2-trifluoroethyl)ether, ethyl(2-fluoroethyl)ether, ethyl(2,2,2-trifluoroethyl)ether, ethyl(1,1,2,2-tetrafluoroethyl)ether, (2-fluoroethyl)(2,2,2-trifluoroethyl)ether, (2-fluoroethyl)(1,1,2,2-tetrafluoroethyl)ether, (2,2,2-trifluoroethyl)(1,1,2,2-tetrafluoroethyl)ether, ethyl n-propyl ether, ethyl(3-fluoro-n-propyl) ether, ethyl(3,3,3-trifluoro-n-propyl)ether, ethyl(2,2,3,3-tetrafluoro-n-propyl)ether, ethyl(2,2,3,3,3-pentafluoro-n-propyl)ether, 2-fluoroethyl-n-propyl ether, (2-fluoroethyl)(3-fluoro-n-propyl)ether, (2-fluoroethyl)(3,3,3-trifluoro-n-propyl)ether, (2-fluoroethyl)(2,2,3,3-tetrafluoro-n-propyl)ether, (2-fluoroethyl)(2,2,3,3,3-pentafluoro-n-propyl)ether, 2,2,2-trifluoroethyl n-propyl ether, (2,2,2-trifluoroethyl)(3-fluoro-n-propyl)ether, (2,2,2-trifluoroethyl)(3,3,3-trifluoro-n-propyl)ether, (2,2,2-trifluoroethyl)(2,2,3,3-tetrafluoro-n-propyl)ether, (2,2,2-trifluoroethyl)(2,2,3,3,3-pentafluoro-n-propyl)ether, 1,1,2,2-tetrafluoroethyl n-propyl ether, (1,1,2,2-tetrafluoroethyl)(3-fluoro-n-propyl)ether, (1,1,2,2-tetrafluoroethyl)(3,3,3-trifluoro-n-propyl)ether, (1,1,2,2-tetrafluoroethyl)(2,2,3,3-tetrafluoro-n-propyl)ether, (1,1,2,2-tetrafluoroethyl)(2,2,3,3,3-pentafluoro-n-propyl)ether, di(n-propyl)ether, (n-propyl)(3-fluoro-n-propyl)ether, (n-propyl)(3,3,3-trifluoropropyl)ether, (n-propyl)(2,2,3,3-tetrafluoro-n-propyl)ether, (n-propyl)(2,2,3,3,3-pentafluoro-n-propyl)ether, bis(3-fluoro-n-propyl)ether, (3-fluoro-n-propyl)(3,3,3-trifluoro-n-propyl)ether, (3-fluoro-n-propyl)(2,2,3,3-tetrafluoro-n-propyl)ether, (3-fluoro-n-propyl)(2,2,3,3,3-pentafluoro-n-propyl)ether, bis(3,3,3-trifluoro-n-propyl)ether, (3,3,3-trifluoro-n-propyl)(2,2,3,3-tetrafluoro-n-propyl)ether, (3,3,3-trifluoro-n-propyl)(2,2,3,3,3-pentafluoro-n-propyl)ether, bis(2,2,3,3-tetrafluoro-n-propyl)ether, (2,2,3,3-tetrafluoro-n-propyl)(2,2,3,3,3-pentafluoro-n-propyl)ether, bis(2,2,3,3,3-pentafluoro-n-propyl) ether, di(n-butyl)ether, dimethoxymethane, methoxyethoxymethane, methoxy(2-fluoroethoxy)methane, methoxy(2,2,2-trifluoroethoxy)methane, methoxy(1,1,2,2-tetrafluoroethoxy)methane, diethoxymethane, ethoxy(2-fluoroethoxy)methane, ethoxy(2,2,2-trifluoroethoxy)methane, ethoxy(1,1,2,2-tetrafluoroethoxy)methane, bis(2-fluoroethoxy)methane, (2-fluoroethoxy)(2,2,2-trifluoroethoxy)methane, (2-fluoroethoxy)(1,1,2,2-tetrafluoroethoxy)methane, bis(2,2,2-trifluoroethoxy)methane, (2,2,2-trifluoroethoxy)(1,1,2,2-tetrafluoroethoxy)methane, bis(1,1,2,2-tetrafluoroethoxy)methane, dimethoxyethane, methoxyethoxyethane, methoxy(2-fluoroethoxy)ethane, methoxy(2,2,2-trifluoroethoxy)ethane, methoxy(1,1,2,2-tetrafluoroethoxy)ethane, diethoxyethane, ethoxy(2-fluoroethoxy)ethane, ethoxy(2,2,2-trifluoroethoxy)ethane, ethoxy(1,1,2,2-tetrafluoroethoxy)ethane, bis(2-fluoroethoxy)ethane, (2-fluoroethoxy)(2,2,2-trifluoroethoxy)ethane, (2-fluoroethoxy)(1,1,2,2-tetrafluoroethoxy)ethane, bis(2,2,2-trifluoroethoxy)ethane, (2,2,2-trifluoroethoxy)(1,1,2,2-tetrafluoroethoxy)ethane, bis(1,1,2,2-tetrafluoroethoxy)ethane, ethylene glycol di(n-propyl)ether, ethylene glycol di(n-butyl)ether, and diethylene glycol dimethyl ether, and the like; examples of the cyclic ether with 3-6 carbon atoms include: tetrahydrofuran, 2-methyltetrahydrofuran, 3-methyltetrahydrofuran, 1,3-dioxolane, 2-methyl-1,3-dioxolane, 4-methyl-1,3-dioxolane, 1,4-dioxolane, and the fluorinated compound thereof;
in the presence of the ether compound exists as an auxiliary solvent and the negative electrode active material is carbonaceous material, it is easy to avoid the problem of capacity decline due to the co-intercalation of the ether compound with lithium ion;
the sulfone compound can be chosen as: dimethyl sulfone, ethyl methyl sulfone, diethyl sulfone, n-propyl methyl sulfone, isopropyl methyl sulfone, n-butyl methyl sulfone, tert-butyl methyl sulfone, monofluoromethyl methyl sulfone, difluoromethyl methyl sulfone, trifluoromethyl methyl sulfone, monofluoroethyl methyl sulfone, difluoroethyl methyl sulfone, trifluoroethyl methyl sulfone, pentafluoroethyl methyl sulfone, ethyl monofluoromethyl sulfone, ethyl difluoromethyl sulfone, ethyl trifluoromethyl sulfone, ethyl trifluoroethyl sulfone, ethyl pentafluoroethyl sulfone, trifluoromethyl n-propyl sulfone, trifluoromethyl isopropyl sulfone, trifluoroethyl n-butyl sulfone, trifluoroethyl tert-butyl sulfone, trifluoromethyl n-butyl sulfone, trifluoromethyl tert-butyl sulfone, and the like; in the presence of the sulfone compound exists as an auxiliary solvent, the cycling performance and cycle retention performance of the battery can be improved, the solution viscosity can be reduced, and the electrochemical performance can be enhanced.

Meanwhile, the present application further provides a lithium-ion battery, including a positive electrode, a negative electrode, a separator and the electrolytic solution as described above.

In the lithium-ion battery, an active material in the positive electrode is one or more of Li₁₊ₐ(NiₓCo_{y}M_{1-x-y})O₂, Li(NiₚMn_{q}Co_{2-p-q})O₄ and LiMₕ(PO₄)ₘ;
where 0≤a≤0.3, 0≤x≤1, 0≤y≤1, and 0≤x+y≤1; 0≤p≤2, 0≤q≤2, and 0≤p+q≤2; 0<h<5, and 0<m<5; and M is Fe, Ni, Co, Mn, Al or V;
a negative electrode active material in the negative electrode includes at least one of carbonaceous material, silicon-carbon material, alloy material and lithium-containing metal composite oxide material, but it is not limited to that, and the negative electrode active material can be chosen as the various traditional known materials which can be used as a negative electrode active material of electrochemical device and can electrochemically intercalate and deintercalate active ions;
a method of preparing a negative electrode plate is well known in the art that can be used in an electrochemical device; a negative electrode active material layer further includes an adhesive and a solvent. A negative electrode is prepared by adding an adhesive and a solvent to the negative electrode active material, along with a thickening agent, a conductive agent, a filler, and the like as required. Then, coating the negative electrode slurry on a negative electrode current collector, drying and pressing to prepare a negative electrode plate, and drying and cold pressing the negative electrode slurry to form a negative electrode active material layer. Similarly, in the preparation of negative electrode slurry, a solvent is usually added. The solvent is removed during the drying process. The adhesive is well known in the art that can be used as the adhesive of the negative electrode active material layer, such as, but is not limited to styrene-butadiene rubber. The solvent is well known in the art that can be used as the solvent of the negative electrode active material layer, such as, but is not limited to water. The thickening agent is well known in the art that can be used as the thickening agent of the negative electrode active material layer, such as, but is not limited to carboxymethyl cellulose. In some embodiments, when the negative electrode active material includes an alloy material, the negative electrode active material layer can be formed by evaporation deposition, sputtering, plating and the like;
a separator is a well-known separator in the art, which can be used in an electrochemical device and is stable for the electrolytic solution as used, such as, but is not limited to, resin, glass fiber and inorganic substance.

For example, the separator includes at least one of polyolefin, aromatic polyamide, polytetrafluoroethylene and polyethersulfone. Preferably, the polyolefin includes polyethylene and/or polypropylene. Preferably, the polyolefin includes polypropylene. Preferably, the separator is made of multiple layers of material stacked on top of each other, for example, the separator is a three-layer separator layered in the sequence of polypropylene, polyethylene, and polypropylene.

Preferably, the negative electrode material is selected from the group consisting of graphite, soft carbon, hard carbon, silicon, a silicon oxide compound, a silicon-carbon complex, and a combination thereof; and
the separator can be selected from the group consisting of PP, PE, PP/PE/PP separator, ceramic-coated PE separator, boehmite-coated PE separator, and a combination thereof.

Finally, the present application further provides a method for improving high-temperature performance and low-temperature performance of the lithium-ion battery, which includes: adding any one of the electrolytic solution as described above to the lithium-ion battery.

Compared with the prior art, the present application has the following beneficial effects:
the electrolytic solution of the present application is stable in storage, and can improve the high- and low-temperature performance and long cycling performance of the lithium-ion battery synergistically after applying the electrolytic solution to the lithium-ion battery.

In the traditional technology, when used individually, lithium tetrafluoro(oxalato)phosphate (LiTFOP) shows relatively good improvements in low-temperature DCR, low-temperature discharge and high-voltage room-temperature cycling, but it has certain adverse effects on high-temperature storage and high-temperature cycling. At the same time, LiTFOP itself is unstable and easy to decompose, leading to a serious increase in the acid value of the electrolytic solution, which is not conducive to quality management;
an imidazolyl group in an imidazole compound can combine with H F or water to form N+ ions and form ion pairs with anions, thus inhibiting the increase of acid value of the electrolytic solution containing LiTFOP, improving the stability of the electrolytic solution, preventing HF from corroding positive electrode materials, inhibiting the dissolution of transition metals, slowing down the storage and gas generation of the electrolytic solution, and improving high-temperature storage and cycling.

At the same time, the active groups in imidazole derivatives can synergize with LiTFOP to form an SEI film, which can improve the uniformity and conductivity of the SEI film, improve the DCR before and after high-temperature storage, and has compatibility with the high- and low-temperature performance and cycling performance of the battery.

### DETAILED DESCRIPTION OF THE INVENTION

The following provides a clear and complete description of the technical scheme in the embodiment of the present application. Obviously, the described embodiment is only a part of the embodiment of the present application, not the whole embodiment. Based on the embodiments in the present application, all other embodiments obtained by ordinary technicians in the art without creative work belong to the protection scope of the present application.

### Part I

### Method of Preparing a Battery:

In the embodiment, a lithium secondary battery consists of a positive electrode, a negative electrode and a separator, where the positive electrode material was LiNi_{0.5}Co_{0.2}Mn_{0.3}O₂, the negative electrode material was artificial graphite, and the separator was a polyethylene membrane coated ceramic separator, and the lithium secondary battery with soft package was assembled according to the conventional method.

### Method of Preparing an Electrolytic Solution:

An electrolytic solution were prepared in a glove box under the protection of high purity nitrogen, where the electrolytic solution includes a solvent of ethylene carbonate and methyl ethyl carbonate in a mass ratio of 1:2, 1M LiPF₆ (12.5 wt %), and 0.5 wt % vinylene carbonate. Compound A and LiTFOP were added to the electrolytic solution according to the embodiment.

TABLE 1
Specific composition and amount (wt %) of electrolytic solution in Examples and
Comparative Examples

| | Lithium | LiTFOP/ | | Other | Non-aqueous |
|---|---|---|---|---|---|
| | salt | % | Compound A | additives | solvent |
| Example 1 | 1M | 0.1 | 0.05% Compound 1 | 0.5% VC | EC:EMC = 1:2 |
| | LiPF₆ | | | | |
| Example 2 | 1M | 0.5 | 0.1% Compound 2 | 0.5% VC | EC:EMC = 1:2 |
| | LiPF₆ | | | | |
| Example 3 | 1M | 0.1 | 0.2% Compound 3 | 0.5% VC | EC:EMC = 1:2 |
| | LiPF₆ | | | | |
| Example 4 | 1M | 0.5 | 0.3% Compound 4 | 0.5% VC | EC:EMC = 1:2 |
| | LiPF₆ | | | | |
| Example 5 | 1M | 0.5 | 0.5% Compound 5 | 0.5% VC | EC:EMC = 1:2 |
| | LiPF₆ | | | | |
| Example 6 | 1M | 0.5 | 1% Compound 6 | 0.5% VC | EC:EMC = 1:2 |
| | LiPF₆ | | | | |
| Example 7 | 1M | 0.5 | 0.5% Compound 7 | 0.5% VC | EC:EMC = 1:2 |
| | LiPF₆ | | | | |
| Example 8 | 1M | 1 | 0.05% Compound 8 | 0.5% VC | EC:EMC = 1:2 |
| | LiPF₆ | | | | |
| Example 9 | 1M | 1 | 1% Compound 9 | 0.5% VC | EC:EMC = 1:2 |
| | LiPF₆ | | | | |
| Example 10 | 1M | 1 | 0.5% Compound 10 | 0.5% VC | EC:EMC = 1:2 |
| | LiPF₆ | | | | |
| Example 11 | 1M | 0.5 | 0.3% Compound 11 | 0.5% VC | EC:EMC = 1:2 |
| | LiPF₆ | | | | |
| Example 12 | 1M | 0.5 | 0.5% Compound 12 | 0.5% VC | EC:EMC = 1:2 |
| | LiPF₆ | | | | |
| Example 13 | 1M | 0.5 | 0.3% Compound 1 | 0.5% VC | EC:EMC = 1:2 |
| | LiPF₆ | | | | |
| Example 14 | 1M | 1 | 0.1% Compound 2 | 0.5% VC | EC:EMC = 1:2 |
| | LiPF₆ | | | | |
| Example 15 | 1M | 0.5 | 0.5% Compound 8 | 0.5% VC | EC:EMC = 1:2 |
| | LiPF₆ | | | | |
| Example 16 | 1M | 0.5 | 0.5% Compound 9 | 0.5% VC | EC:EMC = 1:2 |
| | LiPF₆ | | | | |
| Example 17 | 1M | 0.5 | 0.5% Compound 10 | 0.5% VC | EC:EMC = 1:2 |
| | LiPF₆ | | | | |
| Example 18 | 1M | 0.1 | 0.3% Compound 11 | 0.5% VC | EC:EMC = 1:2 |
| | LiPF₆ | | | | |
| Example 19 | 1M | 0.1 | 0.5% Compound 12 | 0.5% VC | EC:EMC = 1:2 |
| | LiPF₆ | | | | |
| Comparative | 1M | × | 0.3% Compound 1 | 0.5% VC | EC:EMC = 1:2 |
| Example 1 | LiPF₆ | | | | |
| Comparative | 1M | × | 0.1% Compound 2 | 0.5% VC | EC:EMC = 1:2 |
| Example 2 | LiPF₆ | | | | |
| Comparative | 1M | × | 0.5% Compound 8 | 0.5% VC | EC:EMC = 1:2 |
| Example 3 | LiPF₆ | | | | |
| Comparative | 1M | × | 0.5% Compound 9 | 0.5% VC | EC:EMC = 1:2 |
| Example 4 | LiPF₆ | | | | |
| Comparative | 1M | × | 0.5% Compound 10 | 0.5% VC | EC:EMC = 1:2 |
| Example 5 | LiPF₆ | | | | |
| Comparative | 1M | × | 0.3% Compound 11 | 0.5% VC: | EC:EMC = 1:2 |
| Example 6 | LiPF₆ | | | | |
| Comparative | 1M | × | 0.5% Compound 12 | 0.5% VC | EC:EMC = 1:2 |
| Example 7 | LiPF₆ | | | | |
| Comparative | 1M | 0.5 | × | 0.5% VC | EC:EMC = 1:2 |
| Example 8 | LiPF₆ | | | | |
| Comparative | 1M | 0.5 | 0.01% Compound 1 | 0.5% VC | EC:EMC = 1:2 |
| Example 9 | LiPF₆ | | | | |
| Comparative | 1M | 0.5 | 2% Compound 1 | 0.5% VC | EC:EMC = 1:2 |
| Example 10 | LiPF₆ | | | | |
| Comparative | 1M | 0.5 | 0.03% Compound 2 | 0.5% VC | EC:EMC = 1:2 |
| Example 11 | LiPF₆ | | | | |
| Comparative | 1M | 0.5 | 2% Compound 2 | 0.5% VC | EC:EMC = 1:2 |
| Example 12 | LiPF₆ | | | | |
| Comparative | 1M | 0.5 | 0.01% Compound 10 | 0.5% VC | EC:EMC = 1:2 |
| Example 13 | LiPF₆ | | | | |
| Comparative | 1M | 0.5 | 1.5% Compound 10 | 0.5% VC | EC:EMC = 1:2 |
| Example 14 | LiPF₆ | | | | |
| Comparative | 1M | 0.5 | 0.03% Compound 12 | 0.5% VC | EC:EMC = 1:2 |
| Example 15 | LiPF₆ | | | | |
| Comparative | 1M | 0.5 | 2% Compound 12 | 0.5% VC | EC:EMC = 1:2 |
| Example 16 | LiPF₆ | | | | |
| Comparative | 1M | 0.5 | 0.5% 1- | 0.5% VC | EC:EMC = 1:2 |
| Example 17 | LiPF₆ | | (Trifluoromethylsul- | | |
| | | | fonyl) imidazole | | |
| Comparative | 1M | 0.5 | 0.5% ethyl 1H- | 0.5% VC | EC:EMC = 1:2 |
| Example 18 | LiPF₆ | | imidazole-1- | | |
| | | | carboxylate | | |
| Comparative | 1M | 0.5 | 0.5% Imidazole | 0.5% VC | EC:EMC = 1:2 |
| Example 19 | LiPF₆ | | | | |
| Comparative | 1M | 0.5 | 0.5% | 0.5% VC | EC:EMC = 1:2 |
| Example 20 | LiPF₆ | | Trimethylphenoxysi- | | |
| | | | lane | | |
| Comparative | 1M | 0.5 | 0.3% Imidazole + 0.5% | 0.5% VC | EC:EMC = 1:2 |
| Example 21 | LiPF₆ | | Trimethylphenoxysilane | | |
| Comparative | 1M | × | × | 0.5% VC | EC:EMC = 1:2 |
| Example 22 | LiPF₆ | | | | |
| Comparative | 1M | 0.5% | 0.3% Compound 1 | 0.5% VC | EC:EMC = 1:2 |
| Example 23 | LiPF₆ | Lithium | | | |
| | | difluorobis | | | |
| | | (oxalato) | | | |
| | | phosphate | | | |

### Part II

### Performance Test of the Lithium Secondary Battery

The lithium secondary batteries in Examples 1 to 19 and Comparative Examples 1 to 23 were tested for high-temperature performance and low-temperature performance, and the test methods were as follows:

Room-temperature cycling performance: the lithium secondary battery was placed at room temperature, charged to 4.2 V at a constant current of 3 C and a constant voltage, and then discharged to 2.7 V at a constant current of 3 C for 500 cycles, and the capacity retention rate of the lithium secondary battery was measured.

$$Capacity retention rate = ( the 500 th discharge capacity / the first discharge capacity ) \times 100 \%$$

High-temperature cycling performance: the lithium secondary battery was placed in an incubator at 45° C., charged to 4.2 V at a constant current of 3 C and a constant voltage, and then discharged to 2.7 V at a constant current of 3 C for 500 cycles, and the capacity retention rate of the lithium secondary battery was measured.

$$Capacity retention rate = ( the 500 th discharge capacity / the first discharge capacity ) \times 100 \%$$

Low-temperature cycling performance: the lithium secondary battery was placed in an explosion-proof refrigerator at 0° C. and stored for 4 h. After the temperature of the battery dropped to 0° C., the battery was charged to 4.2 V at a constant current of 0.2 C and a constant voltage, and then discharged to 2.7 V at a constant current of 0.5 C for 100 cycles, and the capacity retention rate of the lithium secondary battery was measured.

$$Capacity retention rate = ( the 100 th discharge capacity / the first discharge capacity ) \times 100 \%$$

DCR performance before high-temperature storage: the lithium secondary battery was charged to 4.2 V at room temperature at a constant current of 1 C and a constant voltage before storage, and then discharged at 1 C for 30 min to 50% SOC, rested for 40 min, and the voltage V1 was recorded; then the lithium secondary battery was discharged at a constant current of 2 C for 10 s, and the voltage V2 and current I were recorded.

$$R = Δ U / I = ( V 1 - V 2 ) / I$$

High-temperature storage performance: the formed lithium secondary battery was charged to 4.2 V at room temperature at a constant current of 1 C and a constant voltage, and the initial capacity of the battery was measured, and the thickness of the lithium-ion battery was measured and recorded as H0. Then the lithium secondary battery was taken out after being stored at 60° C. for 30 days, and the thickness H1 was measured first, and then the lithium secondary battery was discharged to 2.7 V at a current of 1 C after cooling to room temperature, the discharge capacity of lithium secondary battery was measured. Then the lithium secondary battery was charged to 4.2 V at a constant current of 1 C and a constant voltage, and then discharged to 2.7 V at a current of 1 C, and the recovery capacity of lithium secondary battery was measured.

$$Capacity retention rate of high - temperature storage = ( discharge capacity after storage / discharge capacity before storage ) \times 100 \%$$

$$Capacity recovery rate of high - temperature storage = ( recovery capacity after storage / discharge capacity before storage ) \times 100 \%$$

DCR performance after high-temperature storage: the lithium secondary battery was charged to 4.2 V at room temperature at a constant current of 1 C and a constant voltage after storage, then discharged at 1 C for 30 min to 50% SOC, rested for 40 min, and the voltage V1 was recorded; then the lithium secondary battery was discharged at a constant current of 2 C for 10 s, and the voltage V2 and current I were recorded.

$$R = Δ U / I = ( V 1 - V 2 ) / I$$

Low-temperature storage performance: the lithium secondary battery was charged at room temperature at a constant current of 1 C to a voltage of 4.2V, and then the battery was placed in a low-temperature cabinet at −20° C., rested for >4 h. After the temperature of the battery dropped to −20° C., the battery was discharged at 0.5 C to 2.7 V.

$$Discharge capacity retention rate at - 20 ° C . = ( discharge capacity at 0.2 C at - 20 ° C . / discharge capacity at room temperature ) \times 100 \%$$

### Test of the Acid Value of the Electrolytic Solution:

The testing was conducted in accordance with 4.5.1 in SJ/T 11723-2018 for electrolytic solution for the lithium-ion battery. After calibrating the potentiometric titrator, 10.00 g of the electrolytic solution sample was accurately weighed and dissolved in 50 mL of anhydrous ethanol. The solution was titrated with a 0.01 mol/L weak organic base, the titration volume was recorded, and the instrument was allowed to automatically calculate the free acid content (calculated as H F) in the electrolytic solution.

The test results of the electrochemical performance are shown in Table 2 and Table 3;

TABLE 2
Test results of electrochemical performances of Examples

| | | | | | Capacity | Capacity | DCR | DCR | |
|---|---|---|---|---|---|---|---|---|---|
| | | | | | retention | recovery | before | after | |
| | | | | | rate after | rate after | being | being | Capacity |
| | | | 1000 Cycles | 800 Cycles | being | being | stored at | stored | retention |
| | | | at room | at high | stored at | stored at | 60° C. | at 60° C. | rate of |
| | | Compound | temper- | temper- | 60° C. for | 60° C. for | for | for | 0.5 C at |
| No. | LiTFOP | A | ature/% | ature/% | 30 D/% | 30 D/% | 30 D/mΩ | 30 D/mΩ | 60° C./% |
| Example | 0.1 | 0.05% | 84.4 | 70.5 | 76.2 | 81.7 | 52.4 | 56.4 | 78.8 |
| 1 | | Compound | | | | | | | |
| | | 1 | | | | | | | |
| Example | 0.5 | 0.1% | 91.2 | 86.3 | 90.1 | 93.4 | 53.1 | 55.4 | 84.5 |
| 2 | | Compound | | | | | | | |
| | | 2 | | | | | | | |
| Example | 0.1 | 0.2% | 84.8 | 76.7 | 83.4 | 85.7 | 53.2 | 55.4 | 82.1 |
| 3 | | Compound | | | | | | | |
| | | 3 | | | | | | | |
| Example | 0.5 | 0.3% | 89.2 | 87.2 | 91.2 | 93.3 | 53.8 | 55.5 | 82.7 |
| 4 | | Compound | | | | | | | |
| | | 4 | | | | | | | |
| Example | 0.5 | 0.5% | 93.3 | 85.4 | 90.5 | 93.5 | 53.4 | 55.7 | 83.8 |
| 5 | | Compound | | | | | | | |
| | | 5 | | | | | | | |
| Example | 0.5 | 1% | 92.3 | 87.6 | 92.7 | 94.5 | 53.2 | 55.1 | 83.2 |
| 6 | | Compound | | | | | | | |
| | | 6 | | | | | | | |
| Example | 0.5 | 0.5% | 90.3 | 86.7 | 92.2 | 94.1 | 53.1 | 54.8 | 84.4 |
| 7 | | Compound | | | | | | | |
| | | 7 | | | | | | | |
| Example | 1 | 0.05% | 88.7 | 74.7 | 79.8 | 84.7 | 52.8 | 54.9 | 82.3 |
| 8 | | Compound | | | | | | | |
| | | 8 | | | | | | | |
| Example | 1 | 1% | 89.2 | 88.8 | 90.3 | 92.3 | 53.2 | 55.7 | 81.4 |
| 9 | | Compound | | | | | | | |
| | | 9 | | | | | | | |
| Example | 1 | 0.5% | 88.7 | 85.3 | 87.6 | 91.2 | 53.8 | 54.7 | 84.5 |
| 10 | | Compound | | | | | | | |
| | | 10 | | | | | | | |
| Example | 0.5 | 0.3% | 91.4 | 84.5 | 90.5 | 95.2 | 51.8 | 54.9 | 83.4 |
| 11 | | Compound | | | | | | | |
| | | 11 | | | | | | | |
| Example | 0.5 | 0.5% | 90.2 | 88.2 | 90.2 | 94.3 | 54.3 | 55.1 | 84.2 |
| 12 | | Compound | | | | | | | |
| | | 12 | | | | | | | |
| Example | 0.5 | 0.3% | 93.2 | 85.7 | 90.5 | 92.4 | 54.2 | 56.2 | 82.2 |
| 13 | | Compound | | | | | | | |
| | | 1 | | | | | | | |
| Example | 1 | 0.1% | 90.2 | 81.6 | 87.6 | 89.3 | 53.8 | 56.3 | 85.2 |
| 14 | | Compound | | | | | | | |
| | | 2 | | | | | | | |
| Example | 0.5 | 0.5% | 89.9 | 84.2 | 88.8 | 91.9 | 53.2 | 55.9 | 79.2 |
| 15 | | Compound | | | | | | | |
| | | 8 | | | | | | | |
| Example | 0.5 | 0.5% | 90.5 | 80.2 | 89.7 | 93.2 | 52.7 | 55.1 | 83.4 |
| 16 | | Compound | | | | | | | |
| | | 9 | | | | | | | |
| Example | 0.5 | 0.5% | 90.2 | 86.3 | 88.7 | 93.4 | 54.2 | 57.2 | 83.4 |
| 17 | | Compound | | | | | | | |
| | | 10 | | | | | | | |
| Example | 0.1 | 0.3% | 86.6 | 82.4 | 89.3 | 93.7 | 52.3 | 55.4 | 78.1 |
| 18 | | Compound | | | | | | | |
| | | 11 | | | | | | | |
| Example | 0.1 | 0.5% | 86.6 | 84.5 | 84.4 | 88.9 | 54.2 | 55.7 | 79.2 |
| 19 | | Compound | | | | | | | |
| | | 12 | | | | | | | |

TABLE 3
Test results of electrochemical performances of Comparative Examples

| | | | | | Capacity | Capacity | DCR | DCR | |
|---|---|---|---|---|---|---|---|---|---|
| | | | | | retention | recovery | before | after | |
| | | | | | rate after | rate after | being | being | Capacity |
| | | | 1000 Cycles | 800 Cycles | being | being | stored at | stored at | retention |
| | | | at room | at high | stored at | stored at | 60° C. | 60° C. | rate of |
| | | | temper- | temper- | 60° C. for | 60° C. for | for | for | 0.5 C at |
| No. | LiTFOP | Compound A | ature/% | ature/% | 30 D/% | 30 D/% | 30 D/mΩ | 30 D/mΩ | 60° C./% |
| Comparative | x | 0.3% | 80.2 | 77.9 | 81.5 | 86.4 | 55.8 | 60.2 | 70.7 |
| Example 1 | | Compound 1 | | | | | | | |
| Comparative | x | 0.1% | 79.8 | 78.4 | 84.6 | 89.1 | 56.6 | 62.8 | 69.6 |
| Example 2 | | Compound 2 | | | | | | | |
| Comparative | x | 0.5% | 80.9 | 79.9 | 83.6 | 88.2 | 54.6 | 59.2 | 72.3 |
| Example 3 | | Compound 8 | | | | | | | |
| Comparative | x | 0.5% | 78.2 | 78.2 | 80.2 | 83.5 | 53.5 | 57.6 | 70.4 |
| Example 4 | | Compound 9 | | | | | | | |
| Comparative | x | 0.5% | 80.6 | 74.7 | 82.7 | 89.3 | 56.7 | 60.9 | 70.8 |
| Example 5 | | Compound 10 | | | | | | | |
| Comparative | x | 0.3% | 78.2 | 76.2 | 84.5 | 88.5 | 52.9 | 58.8 | 68.4 |
| Example 6 | | Compound 11 | | | | | | | |
| Comparative | x | 0.5% | 80.7 | 77.5 | 83.4 | 87.2 | 54.4 | 57.9 | 73.3 |
| Example 7 | | Compound 12 | | | | | | | |
| Comparative | 0.5 | x | 83.2 | 61.5 | 70.5 | 74.7 | 52.8 | 59.2 | 81.5 |
| Example 8 | | | | | | | | | |
| Comparative | 0.5 | 0.01% | 79.5 | 62 | 72.7 | 75.1 | 53.1 | 58.1 | 79.1 |
| Example 9 | | Compound 1 | | | | | | | |
| Comparative | 0.5 | 2% | 77.5 | 64.5 | 73.4 | 77.3 | 57.2 | 66.4 | 70.4 |
| Example 10 | | Compound 1 | | | | | | | |
| Comparative | 0.5 | 0.03% | 79.2 | 62.4 | 70.4 | 75.2 | 53.4 | 57.6 | 78.3 |
| Example 11 | | Compound 2 | | | | | | | |
| Comparative | 0.5 | 2% | 78.5 | 65.2 | 72.9 | 75.2 | 56.8 | 61.2 | 70.3 |
| Example 12 | | Compound 2 | | | | | | | |
| Comparative | 0.5 | 0.01% | 80.1 | 62.3 | 71.1 | 73.2 | 53 | 58.3 | 80.8 |
| Example 13 | | Compound 10 | | | | | | | |
| Comparative | 0.5 | 1.5% | 78.3 | 64.5 | 71.4 | 76.7 | 59.2 | 63.6 | 68.7 |
| Example 14 | | Compound 10 | | | | | | | |
| Comparative | 0.5 | 0.03% | 79.7 | 62.5 | 71.5 | 75.3 | 53.6 | 57.7 | 77.3 |
| Example 15 | | Compound 12 | | | | | | | |
| Comparative | 0.5 | 2% | 73.1 | 66.3 | 73.4 | 78.9 | 60.9 | 68.2 | 62.4 |
| Example 16 | | Compound 12 | | | | | | | |
| Comparative | 0.5 | 0.5% | 78.1 | 60.4 | 67.8 | 70.2 | 54.2 | 61.7 | 67.8 |
| Example 17 | | 1-(Trifluoro | | | | | | | |
| | | methylsulfonyl) | | | | | | | |
| | | imidazole | | | | | | | |
| Comparative | 0.5 | 0.5% Ethyl | 80.1 | 62.5 | 74.2 | 77.7 | 52.8 | 59.2 | 69.7 |
| Example 18 | | 1H-imidazole − | | | | | | | |
| | | 1-carboxylate | | | | | | | |
| Comparative | 0.5 | 0.5% | 78.7 | 66.7 | 73.4 | 75.5 | 54.6 | 59.6 | 68.3 |
| Example 19 | | Imidazole | | | | | | | |
| Comparative | 0.5 | 0.5% | 77.3 | 67.5 | 74.4 | 76.5 | 53.4 | 58.4 | 70.2 |
| Example 20 | | Trimethyl | | | | | | | |
| | | phenoxysilane | | | | | | | |
| Comparative | 0.5 | 0.3% | 75.7 | 67.7 | 71.2 | 75.6 | 54.4 | 60.2 | 69.6 |
| Example 21 | | Imidazole + | | | | | | | |
| | | 0.5% | | | | | | | |
| | | trimethyl | | | | | | | |
| | | phenoxysilane | | | | | | | |
| Comparative | x | x | 80.2 | 67.8 | 75.3 | 79.2 | 52.6 | 57.5 | 75.7 |
| Example 22 | | | | | | | | | |
| Comparative | 0.5% | 0.3% | 89.7 | 86.5 | 91.3 | 93.5 | 54.7 | 57.1 | 74.8 |
| Example 23 | Lithium | Compound 1 | | | | | | | |
| | difluoro | | | | | | | | |
| | bis(oxalato) | | | | | | | | |
| | phosphate | | | | | | | | |

Refer to Table 4 for the test results of free acid before and after electrolytic solution storage;

TABLE 4
Storage stability test results of examples and
comparative examples

| | free acid at 45° C./(mg/kg) | |
|---|---|---|
| No. | 0D | 30D |
| Comparative | 24.7 | 40.9 |
| Example 7 | | |
| Comparative | 40.8 | 161.8 |
| Example 8 | | |
| Comparative | 38.7 | 89.6 |
| Example 15 | | |
| Example 12 | 36.5 | 46.4 |
| Comparative | 31.4 | 40.1 |
| Example 16 | | |
| Example 19 | 32.5 | 42.9 |

It should be noted that in the Examples and Comparative Examples of the present application, the third additive is not specially limited, and the specific selection of the third additive can be selected according to the requirements of battery performance and the conventional cognition of those skilled in the art; where, as a conventional additive in the art, VC can improve the high- and low-temperature performance of electrolytic solution, improve the specific capacity and cycling life of the battery, and also has overcharge protection effect, and has good compatibility with the positive electrode without negative effects, which is one of the most ideal products in electrolytic solution additives for lithium-ion battery. Through a large number of experiments, the present application has proved that other optional third additives, such as vinyl sulfate and vinyl ethylene carbonate, can improve the performance of the battery in at least one aspect, such as high-temperature cycling or low-temperature cycling, and the like;
in the present application, regardless of the presence or absence of the third additive, the performance trend resulting from the combined use of the first additive and the second additive is unchanged.

### Part III Result Analysis

It can be seen from Table 1 that the comprehensive performance of lithium ion batteries in Examples 1-19 is better than that in Comparative Examples 1-23 in terms of room-temperature cycling performance, high-temperature cycling performance, high-temperature storage performance and low-temperature discharge performance, which shows that the electrolytic solution additives in Examples 1-19 can effectively improve the high- and low-temperature comprehensive performance of lithium secondary battery.

Specifically:
1. Referring to Comparative Example 1 and Example 13, Example 2 and Comparative Example 2, Comparative Example 3 and Example 15, Comparative Example 4 and Example 16, Comparative Example 5 and Example 17, Comparative Example 6 and Example 18, and Comparative Example 7 and Example 19, in the absence of LiTFOP, high-temperature cycling, room-temperature cycling, low-temperature capacity retention, high-temperature storage and DCR growth are all significantly affected.

The reason is that the performance is influenced by two aspects of factors: LiTFOP contributes to the enhancement of conductivity, and LiTFOP and the compound A in the present application can synergistically form a more uniform film.
2. Referring to Example 13 and Comparative Example 23, it can be found that when LiTFOP and LiDFOP are used in combination with compound A, the performance difference is that LiTFOP exhibits better performance than LiDFOP in terms of room-temperature cycling and low-temperature discharge performance, but the improvement effect of LiTFOP on high-temperature storage and high-temperature cycling is not as good as LiDFOP, which shows two points:
1) a core problem in the present application is that LiTFOP is not very stable, and it is easy to decompose to generate HF, while Compound A can form N+ ions and form ion pairs with anions, thus inhibiting the increase of acid value of the electrolytic solution containing LiTFOP. Compound A combines with H F, and the SEI film formed at the same time has good strength. Therefore, the combined use of Compound A in the present application and LiTFOP can show additional effects, such as improving the stability of electrolytic solution and reducing gas generation caused by electrolytic solution decomposition, thereby improving high-temperature performance, reducing battery interface impedance, improving interface conductivity and improving low-temperature discharge;
2) in terms of the basic electrical properties, some properties are similar to those of Comparative Example 23, which shows that as an additive which can also supplement the electrical conductivity, the performance in these properties is consistent.
3. By comparing Comparative Example 9 with Comparative Example 10, Comparative Example 11 with Comparative Example 12, Comparative Example 13 with Comparative Example 14, and Comparative Example 15 with Comparative Example 16, it can be seen that the suitable amount of compound A can achieve relatively good results; especially, when the amount of compound A is more than 1%, the overall effect decreases significantly. The possible reason is that when compound A is too much, too many unsaturated bonds are introduced, and the SEI film formed is too thick, which increases the impedance and reduces the comprehensive performance of the battery.
4. It can be seen from Comparative Examples 17-18 that when the sulfonyl group is connected with trifluoromethyl, or when ethoxyformylimidazole is used, the overall effect is relatively poor. It shows that the overall performance of the product can be improved only when one terminal of the sulfonyl group is connected with imidazolyl and the other terminal is connected with designated active group. The possible reason is that if the connected active group contains benzene ring or imidazole unsaturated heterocyclic ring, N+ ions can be stabilized by large conjugation, and the stability of LiTFOP can be improved. If the connected active group is a basic group such as substituted ammonia, it can synergistically neutralize free acid with imidazolyl, thus improving the stability of electrolytic solution;
it also shows that when carbonyl group is used, the other terminal of carbonyl group is connected with either unsaturated group or silane group, the overall performance of the product can be improved. The possible reasons are as follows: if the connected active group contains an unsaturated bond, a flexible SEI film can be formed by electrochemical initiation polymerization to ensure the stability of electrode material; if the connected active group is a siloxane group, as a group that can easily leave, it can better remove free water and acid synergistically with imidazole, better improve the stability of LiTFOP and improve the high-temperature performance.
5. It can be seen from Table 4 that the compound A of the present application can significantly inhibit the increase of electrolytic solution acidity caused by LiTFOP.

Based on the above analysis, imidazole derivative compound A cannot only inhibit the increase of the electrolytic solution acidity caused by LiTFOP, but further combine with LiTFOP to form a more excellent SEI film and effectively improve the electrical performance of the battery.

1. An electrolytic solution for a lithium-ion battery, wherein the electrolytic solution comprises a first additive and a second additive; the first additive is lithium tetrafluoro(oxalato)phosphate, and the second additive is represented by the following Formula 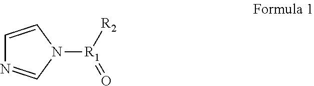
wherein, R₁ is C or S═O;
when R₁ is C, the second additive is represented by the following Formula 2: 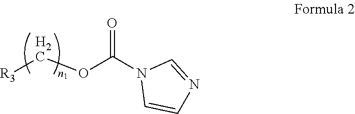
when n₁=0, R₃ is 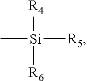
wherein R₄, R₅ and R₆ are each independently selected from the group consisting of F, saturated hydrocarbyl with 1-3 C atoms, unsaturated alkenyl or alkynyl with 2-5 C atoms, and phenyl or substituted phenyl with 6-12 C atoms;
when n₁=1-5, R₃ is —C═C, —C≡C, —CN, or —N═C═O;
when R₁ is S═O, the second additive is represented by the following Formula 3: 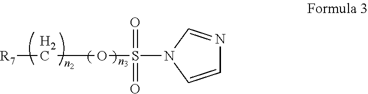
wherein n₃=0 or 1;
when n₃=0, n₂=0, and R₇ is F, phenyl or substituted phenyl with 6-12 C atoms, imidazolyl or 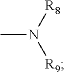
wherein, R₈ and R₉ are each independently selected from the group consisting of saturated hydrocarbyl with 1-3 C atoms, and unsaturated alkenyl or alkynyl with 3-5 C atoms;
when n₃=1, n₂=0, and R₇ is phenyl or substituted phenyl with 6-12 C atoms; or
when n₃=1, n₂=1-3, and R₇ is —C═C, —C≡C, —CN, —N═C═O, phenyl or substituted phenyl with 6-12 C atoms, or imidazolyl.

2. The electrolytic solution according to claim 1, wherein an amount of the first additive is 0.1-1 wt % of a total amount of the electrolytic solution; an amount of the second additive is 0.05-1 wt % of the total amount of the electrolytic solution.

3. The electrolytic solution according to claim 1, wherein the phenyl or substituted phenyl with 6-12 C atoms is selected from the group consisting of phenyl, biphenyl, phenyl having at least one alkyl substituent, naphthyl, naphthyl having one or two methyl substituents, naphthyl having one ethyl substituent, indenyl, and indenyl having at least one alkyl substituent;
the saturated hydrocarbyl with 1-3 C atoms is methyl, ethyl or propyl;
the unsaturated alkenyl or alkynyl with 2-5 C atoms is vinyl, allyl, propenyl, 3-butenyl, isobutenyl, 4-pentenyl, ethynyl, propargyl, 3-butynyl, 1-methyl-2-propynyl, 1-pentenyl, 2-pentenyl, 2-methyl-1-butenyl, 3-methyl-1-butenyl, or 2-methyl-2-butenyl; and
the unsaturated alkenyl or alkynyl with 3-5 C atoms is allyl, propenyl, 3-butenyl, isobutenyl, 4-pentenyl, ethynyl, propargyl, 3-butynyl, 1-methyl-2-propynyl, 1-pentenyl, 2-pentenyl, 2-methyl-1-butenyl, 3-methyl-1-butenyl, or 2-methyl-2-butenyl.

4. The electrolytic solution according to claim 1, wherein the second additive is any one or a combination of two or more of the following compounds:

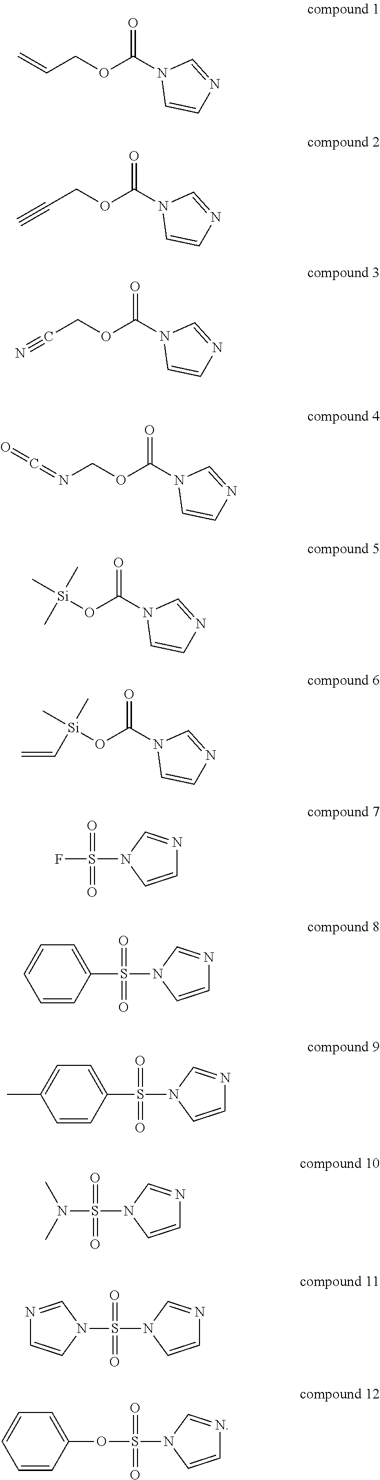

5. The electrolytic solution according to claim 1, wherein the electrolytic solution further comprises a third additive; and an amount of the third additive is 0-10 wt % of the total amount of the electrolytic solution; and
the third additive is selected from the group consisting of:
vinylene carbonate, vinyl ethylene carbonate, ethylene sulfate, propylene carbonate, 1,3-propanesultone, prop-1-ene-1,3-sultone, 1,4-butane sultone, 2,4-butane sultone, succinic anhydride, maleic anhydride, 2-methylmaleic anhydride, methyl 2-propynyl carbonate, tetravinylsilane, triallyl isocyanurate, hexamethylene diisocyanate, o-phenanthroline, p-phenyl diisocyanate, 2,4-toluene diisocyanate, N-phenyl-bis(trifluoromethanesulfonly)imide, bis(ethylene sulfate), phenyl methanesulfonate, pentaerythritol bicyclic sulfate, hydroquinone bisfluorosulfonate, triallyl phosphate, tripropynyl phosphate, 2,4-butane sulfone, isocyanatoethyl methacrylate, methylene methanedisulfonate, tris(trimethylsilyl)borate, tris(trimethylsilyl)phosphate, tris(vinyldimethylsilyl)phosphate, 4,4′-bi-1,3-dioxolane-2,2′-dione, propyl diprop-2-ynyl phosphate, ethyl diprop-2-ynyl phosphate, (2-allylphenoxy)trimethylsilane, tetramethyl methylenediphosphonate, isocyanatoethyl methacrylate, 2-fluoropyridine, and a combination thereof.

6. The electrolytic solution according to claim 5, wherein the amount of the third additive is 0.1-5 wt % of the total amount of the electrolytic solution.

7. The electrolytic solution according to claim 5, wherein the amount of the third additive is 0.1-1 wt % of the total amount of the electrolytic solution.

8. The electrolytic solution according to claim 1, wherein the electrolytic solution comprises a lithium salt and a non-aqueous organic solvent as the balance; and an amount of the lithium salt is 8-25 wt % of the total amount of the electrolytic solution; and
the lithium salt is selected from the group consisting of LiPF₆, LiAsF₆, LiClO₄, LiBF₄, LiB(C₂O₄)₂, LiBF₂C₂O₄, LiTDI, LiN(SO₂F)₂, LiN(SO₂CF₃)₂, LiPO₂F₂, LiPF₂(C₂O₄)₂, lithium perfluorobutane sulfonate, and a combination thereof.

9. The electrolytic solution according to claim 8, wherein the non-aqueous organic solvent is a cyclic compound and/or a linear compound;
the cyclic compound is selected from the group consisting of ethylene carbonate, propylene carbonate, γ-butyrolactone, sulfolane, fluoroethylene carbonate, difluoroethylene carbonate, 4-(2,2,2-trifluoroethoxy)-1,3-dioxolan-2-one, fluoropropylene carbonate, 3,3,3-trifluoropropylene carbonate, 4-(2,2,2-trifluoroethyl)-1,3-dioxolan-2-one, and a combination thereof; and
the linear compound is selected from the group consisting of dimethyl carbonate, ethyl methyl carbonate, diethyl carbonate, methyl propyl carbonate, ethyl acetate, propyl propionate, ethyl propionate, propyl acetate, methyl propionate, 1,1,2,2-tetrafluoroethyl-2,2,3,3-tetrafluoropropyl ether, 2,2-difluoroethyl acetate, trifluoroethyl acetate, ethyl difluoroacetate, ethyl trifluoroacetate, methyl acetate, propylene glycol methyl ether acetate, 2-methoxy-1-propyl acetate, n-propyl acetate, tris(2-ethylhexyl) trimellitate, and a combination thereof.

10. A lithium-ion battery, wherein the lithium-ion battery comprises a positive electrode, a negative electrode, a separator and the electrolytic solution according to claim 1.

11. The lithium-ion battery according to claim 8, wherein an active material in the positive electrode is one or more of Li₁₊ₐ(NiₓCo_{y}M_{1-x-y})O₂, Li(NiₚMn_{q}CO_{2-p-q})O₄ and LiMₕ(PO₄)ₘ;
wherein 0≤a≤0.3, 0≤x≤1, 0≤y≤1, and 0≤x+y≤1; 0≤p≤2, 0≤q≤2, and 0<p+q≤2; 0<h<5, and 0<m<5; and M is Fe, Ni, Co, Mn, Al or V;
the negative electrode material is selected from the group consisting of graphite, soft carbon, hard carbon, silicon, a silicon oxide compound, a silicon-carbon complex, and a combination thereof; and
the separator is selected from the group consisting of PP, PE, PP/PE/PP separator, ceramic-coated PE separator, boehmite-coated PE separator, and a combination thereof.

12. A method for improving high-temperature performance and low-temperature performance of a lithium-ion battery, wherein the method comprises: adding the electrolytic solution according to claim 1 into the lithium-ion battery.
